(19) United States
(12) Patent Application Publication
(10) Pub. No.: US 2025/0156682 A1
(43) Pub. Date: May 15, 2025

(54) GENERATING SYMBOLIC PLANS USING TRANSFORMER-BASED MODELS

(71) Applicants: International Business Machines Corporation, Armonk, NY (US); University of South Carolina, Columbia, SC (US); University of Brescia Italy, Brescia (IT)

(72) Inventors: Francesca Rossi, Mount Kisco, NY (US); Lior Horesh, North Salem, NY (US); Keerthiram Murugesan, White Plains, NY (US); Vishal Pallagani, Columbia, SC (US); Biplav Srivastava, Chapin, SC (US); Andrea Loreggia, Padova (IT)

(21) Appl. No.: 18/509,359

(22) Filed: Nov. 15, 2023

(51) Int. Cl. G06N 3/0455; G06N 3/096

(52) U.S. Cl. CPC G06N 3/0455; G06N 3/096

(57) ABSTRACT

Embodiments of the invention are directed to a computer-implemented method that includes inputting a first input into a plansformer that includes a transformer-based neural network (NN). The first input includes symbols and a problem. The computer-implemented method further includes, in response to the inputting, receiving as output from the plansformer a plan for solving the problem.

### STATEMENT REGARDING PRIOR DISCLOSURE BY THE INVENTORS

The following disclosure is submitted under 35 U.S.C. 102 (b)(1)(A): DISCLOSURE: “Plansformer: Generating Symbolic Plans using Transformers”, Vishal Pallagani, Bharath Muppasani, Keerthiram Murugesan, Francesca Rossi, Lior Horesh, Biplav Srivastava, Francesco Fabiano, and Andrea Loreggia, 16 Dec. 2022, arXiv: 2212.08681v1 [cs.AI], pages 1-44.

### BACKGROUND

The present invention relates in general to programmable computers that automatically generate plans. More specifically, the present invention relates to computing systems, computer-implemented methods, and computer program products that generate symbolic plans using transformer-based machine learning models.

In its simplest form, artificial intelligence (AI) is a field that combines computer science and robust datasets to enable problem-solving. AI also encompasses sub-fields of machine learning and deep learning. Machine learning and deep learning are implemented in some instances as neural networks (NNs) having input layers, hidden layers, and output layers. Machine learning NNs differ from deep learning NNs in that deep learning has more hidden layers than machine learning. AI systems can be implemented as AI algorithms that seek to create expert systems operable to make automatic predictions or classifications based on input data.

AI is used to automate planning processes. The most basic problem in planning is generating a course of action (e.g., a plan or a policy) operable to enable an agent (e.g., a physical agent or a virtual agent) to achieve given goals in its environment starting from a known initial state. Planners are general purpose computer-implemented artificial intelligence solver algorithms that take as input the description of the problem to solve (this describes the actions available to the agent and their effects on the environment) and return a plan (or policy) achieving the problem's goal. At its core a solver is a set of algorithms used to make decisions. Solver algorithms include generators and searchers, which generate potential decisions and then search through them to find the best one in the time given. Planners typically use search or constrained optimization to solve the problem.

### SUMMARY

Embodiments of the invention are directed to a computer-implemented method that includes inputting a first input into a plansformer that includes a transformer-based neural network (NN). The first input includes symbols and a problem. The computer-implemented method further includes, in response to the inputting, receiving as output from the plansformer a plan for solving the problem.

Embodiments of the invention are also directed to computer systems and computer program products having substantially the same features and functionality as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2 depicts a simplified block diagram illustrating a system architecture embodying aspects of the invention;

FIG. 3 depicts a simplified block diagram illustrating another system architecture embodying aspects of the invention;

FIG. 4 depicts a table illustrating a plan dataset of a planning domain operable to be utilized in accordance with aspects of the invention;

FIG. 5 depicts a table illustrating results of model testing operations utilized in accordance with aspects of the invention;

FIG. 6 depicts a table illustrating results of plan validation operations utilized in accordance with aspects of the invention;

FIG. 7 depicts tables illustrating results of model testing operations and/or plan validation operations utilized in accordance with aspects of the invention;

FIG. 8 depicts tables illustrating results of model testing operations and/or plan validation operations utilized in accordance with aspects of the invention;

FIG. 9A depicts a graph illustrating results of model testing operations and/or plan validation operations utilized in accordance with aspects of the invention;

FIG. 9B depicts a graph illustrating results of model testing operations and/or plan validation operations utilized in accordance with aspects of the invention;

FIG. 9C depicts a graph illustrating results of model testing operations and/or plan validation operations utilized in accordance with aspects of the invention; and

FIG. 9D depicts a graph illustrating results of model testing operations and/or plan validation operations utilized in accordance with aspects of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Turning now to an overview of technologies that are more specifically related to aspects of the invention, automated planning is a powerful approach for solving complex planning problems in AI. In symbolic planning, the task is to generate a sequence of actions that can achieve a desired goal based on a set of initial conditions and a description of the world. However, generating effective and efficient plans is a challenging problem, especially in complex domains with large state and action spaces.

Deep learning has been used extensively for perception tasks in computer vision or natural language processing. For example, large language models (LLMs) are transformer-based machine learning models that have significantly advanced prediction and classification operations in various natural language tasks such as question answering, summarization, and text generation. To date, many studies have been conducted to understand and demonstrate the capabilities of LLMs-including their knowledge of the world, syntax, and semantics. However, a plan is a sequence of appropriate actions to apply to achieve the objective/goal when starting from a given state. The present embodiments apply deep learning as a type of machine learning to solve reasoning tasks such as planning. Deep learning has previously mainly been used in reinforcement learning, which enables an agent to learn how to act in its environment by interacting with it and receiving rewards to reinforce desired behavior. Unfortunately, this requires very large amounts of data and computing resources and doesn't easily capture and exploit existing knowledge of the problem. Thus, despite the textual prowess of LLMs, their significance is very limited in the domains that involve symbols. For example, LLMs for domains with symbols, such as mathematics and coding problems, reflect the shortcomings of LLMs when it comes to handling symbols. In automated planning, even state-of-the-art LLMs were previously not able to reason with symbolic data.

Accordingly, there is a need for automated AI planning systems and processes that efficiently and effectively combine reasoning and learning in a variety of domains, including domains that involve symbols.

Turning now to an overview of aspects of the invention, embodiments of the invention provide computing systems, computer-implemented methods, and computer program products that generate symbolic plans using transformer-based models. Embodiments of the invention introduce a novel transformer-based NN architecture referred to herein as a “plansformer,” The plansformer disclosed herein is a novel tool that utilizes a code-aware fine-tuned language model based on transformer architectures to generate symbolic plans. Transformers are a type of NN architecture that have been shown to be highly effective in a range of natural language processing tasks. Unlike traditional planning systems that use heuristic-based search strategies, the plansformer described herein is fine-tuned on specific classical planning domains to generate high-quality plans that are both fluent and feasible. The plansformer described herein takes domain and problem files as inputs (in planning domain definition language “PDDL”) and outputs a sequence of actions that can be executed to solve the problem. Embodiments of the invention demonstrate the effectiveness of the disclosed plansformer on a variety of benchmark problems and provide both qualitative and quantitative results obtained during evaluation of the same. The disclosed plansformer improves the efficiency and effectiveness of planning in various domains, from logistics and scheduling to natural language processing and human-computer interaction.

Embodiments of the invention implement a process referred to herein as “slow and fast planning,” which makes use of the disclosed plansformers as a fast solver in conjunction with the FastDownward system, which is a traditional artificial intelligence planning system. At its core an artificial intelligence solver is a set of algorithms used to make decisions. Solver algorithms include generators and searchers. The generators generate potential decisions and then the searchers search through them to find the best one in the time given For the disclosed plansformer, in accordance with some embodiments of the invention, an initial step in creating the plansformer is creating a planning dataset that includes problems (e.g., about 18,000 problems) of varying complexity for one or more of the following four domains/domain models, namely, Blocksworld, Gripper, Hanoi, and Driver Log. The computer program governing the dataset includes a novel prompt that includes entities present in both domains and problem files along with their original optimal plans generated using the FastDownward planning system. Embodiments of the invention illustrate that a language model pretrained on coding problems is capable of working better with planning instances as opposed to the language models solely trained in natural language. Instead of using a natural language-based pre-trained model that is a text-to-text transformer without any training on symbols such as computer code, embodiments of the invention use a code-aware transformer-based encoder-decoder architecture. The code-aware transformer-based encoder-decoder architecture is produced via performing pre-training on a large language model. The pretraining uses unimodal and bimodal multilingual code corpora and uses one or more pretraining tasks for code understanding and/or code generation such as span denoising, contrastive learning, text-code matching, causal language model pretraining, code summarization, code generation, code translation, code refinement, code defect detection, code clone detection, and text-code matching. Experiments performed in accordance with aspects of the invention show that the syntactic/symbolic knowledge learned from different programming languages such as Python and Java for such a pre-trained code-aware architecture can be beneficial for the planning-domain-definition-language-based (PDDL-based) automated planning task. On the considered testing dataset, the novel plansformer was able to generate 91.8% valid plans, out of which 84.35% are shortest length plans. These results are promising in terms of harnessing LLMs to perform symbolic tasks such as planning.

Thus, embodiments of the invention fine-tune the pre-trained code-aware architecture, which is a language model that is pre-trained on code, with a planning data set. Tuning or fine-tuning is the process of taking a pre-trained model and training it on a new dataset. The pre-trained model has already learned features from another (often large) dataset, and tuning allows these learned features to be adapted to a new dataset. Thus, tuning is a so-called “transfer learning” technique that applies knowledge learned from one task to another related task. A tuning process can involve several steps, including data preparation, choosing the new model's architecture, hyperparameter tuning, training, and evaluation. In data preparation, the new dataset should be split into training, validation, and test sets. The training set is used to train the new model, the validation set is used to tune the hyperparameters, and the test set is used to evaluate the performance of the new model. The pre-trained model can be used as a feature extractor, and the new model can be added on top of it. Alternatively, the pre-trained model can be fine-tuned end-to-end, where all layers of the model are trained on the new dataset. For hyperparameter tuning, hyperparameters are parameters that are not learned during training, such as learning rate, batch size, regularization, and the like. Hyperparameter tuning involves selecting the best values for these parameters to achieve the best performance on the validation set. For training the new model on the new dataset, the pre-trained model is initialized with the weights learned from the pre-training phase, and the new dataset is used to tune or fine-tune the new model. The validation set is used to monitor the performance of the model. In the evaluation step, the performance of the new model is evaluated on the test set. The test set is used to measure the generalization performance of the new model. If the new model performs well on the test set, it can be deployed in a production environment. The disclosed plansformer is then rigorously evaluated for its competency on language-based metrics such as ROUGE-L (or ROUGE) and BLEU scores, as well as planning-based metrics such as plan validity and optimality. In general, optimality is a property of optimization algorithms regarding whether their outcomes are maximal (for maximization problems) or minimal (for minimization problems). The planning-based metrics are used because traditional language based metrics used to test LLMs do not provide definitive evidence on whether the generated output sequence is a sensible valid plan that helps an agent navigate from the initial state to the goal state.

Embodiments of the invention utilize LLMs trained to generate code and adapt them to generate valid plans. In aspects of the invention, a training and test dataset for a planning domain are generated to support analysis of an LLM-based automated planning system generated in accordance with aspects of the invention. The disclosed plansformer is generated in accordance with aspects of the invention, where the plansformer is implemented as a LLM trained to generate symbolic plans of high quality in terms of correctness and length.

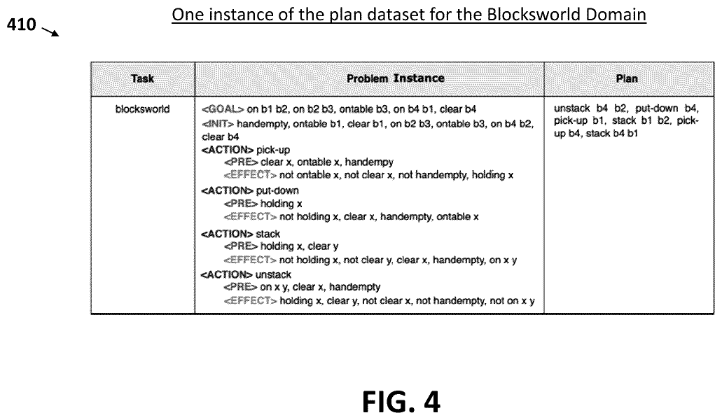

In embodiments of the invention described herein, the above-described features are implemented as a system/architecture having a modeling phase and an inference phase. The modeling phase is operable to create a planning dataset that is used to fine-tune an LLM. The modeling phase includes a software module called a problem generator that is configured and arranged to automatically generate problem files, given a domain model, which in turn are sent to a planner for generating corresponding plans. The dataset is prepared using a combination of the domain, the problem and the associated plan (e.g., as shown in FIG. 4). The dataset so obtained is used to fine-tune a unified pre-trained encoder-decoder transformer model that can leverage code semantics. The model obtained after the fine-tuning phase is the novel plansformer.

The inference phase makes use of the novel plansformer to generate symbolic plans for any new problem. Along with the plan, a confidence score is also generated by the plansformer to provide an overall measurement of how well the generated plan performs. Additionally, embodiments of the invention also incorporate a plan validator tool that can apply validation/optimization techniques to check for the validity and optimality of the plans generated by the plansformer.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

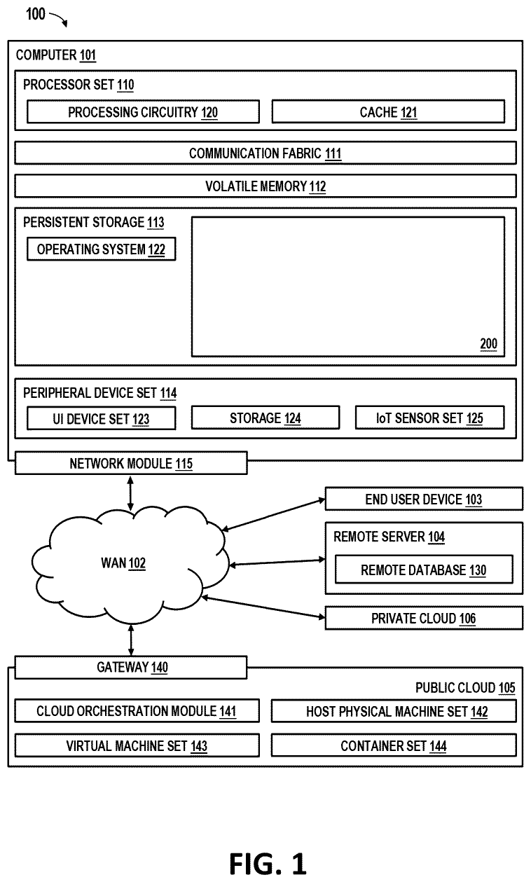

FIG. 1 depicts a computing environment 100 that contains an example of an environment for the execution of at least some of the computer code involved in performing the inventive methods, such as code block 200 operable to generate symbolic plans using transformer-based models. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

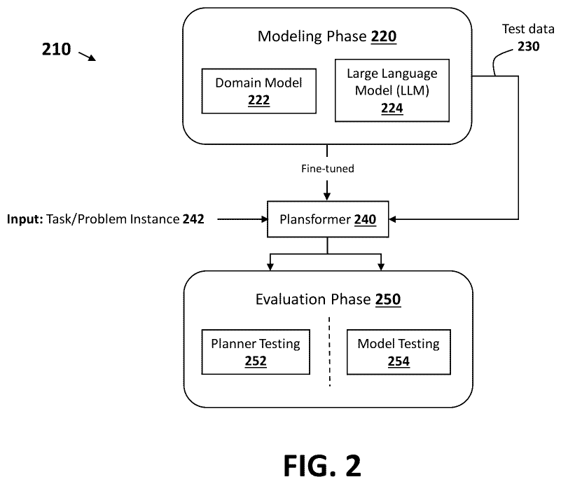

FIG. 2 depicts a simplified block diagram illustrating how the various features and functionality of the computing environment 100 (shown in FIG. 1) can be used to implement a system (or system architecture) 210 in accordance with embodiments of the invention. The system 210 includes a modeling phase 220 operable to generate a novel plansformer 240, which is evaluated by an evaluation phase 250. The modeling phase 220 utilizes a domain model 222 and an LLM 224. The evaluation phase 250 includes planner testing operations 252 and model testing operations 254. The system 210 is operable to generate and test the novel plansformer 240. In the modeling phase 220, an existing LLM 224 is provided and further trained, based on a selected domain model 222, on planning problem instances with corresponding valid plans. In some embodiments of the invention, the LLM 224 includes a code-aware transformer-based model. The evaluation phase 250 is used to test the plansformer 240 to determine whether it generates valid (or almost valid) plans for unseen planning problem instances. Thus, the modeling phase 220 creates the plansformer 240 from the given LLM 224 and the domain model 222, and the evaluation phase 250 is operable to assess the competency of the plansformer 240 as a model and as a planner. More specifically, the modeling phase 220 is operable to create a planning dataset (e.g., plan dataset shown as table 410 shown in FIG. 4) that is used for fine-tuning the LLM 224 in a manner that creates the plansformer 240. In embodiments of the invention, the modeling phase 220 includes a mechanism to automatically generate problem files, given the domain model 222, which in turn are sent to a planner for generating corresponding plans. As previously noted, in some embodiments of the invention, the LLM 224 is pretrained on code generation and further trained on planning problem instances with corresponding valid plans. The evaluation phase 250 evaluates the competence of the plansformer 240 in generating valid plans (or almost valid plans) for unseen planning problem instances using two types of testing, the planner testing 252 and the model testing 254. The model testing 254 measures whether the plansformer 240 is generating meaningful responses (as in the test dataset). The planner testing 252 measures if the generated plans are valid/optimal (independently of whether they were the same plans as in the test dataset).

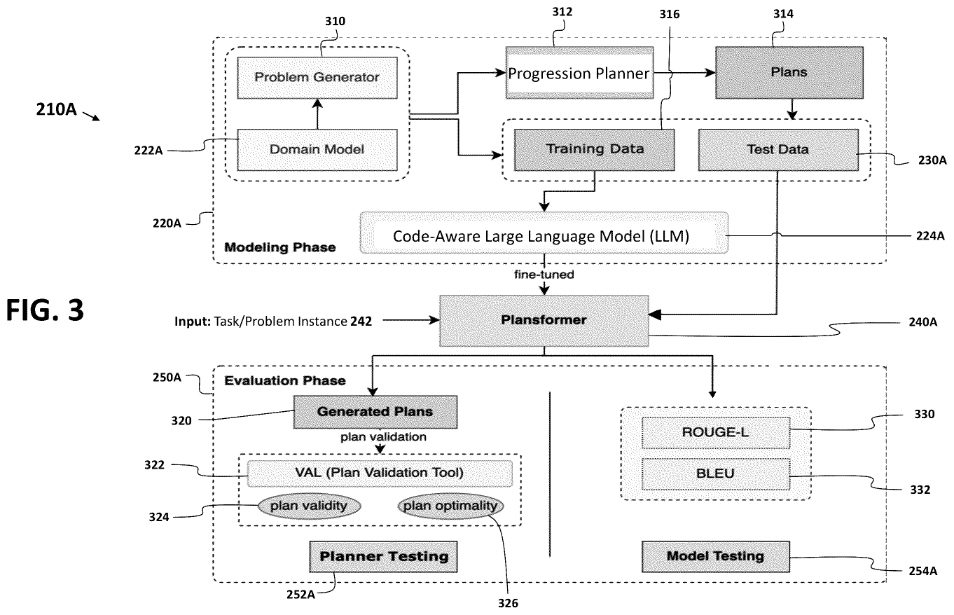

FIG. 3 depicts a simplified block diagram illustrating another system (or system architecture) 210A in accordance with embodiments of the invention. The system 210A includes the features and functionality of the system 210 (shown in FIG. 2) but provides additional details in accordance with aspects of the invention. The system 210A includes a modeling phase 220A operable to generate an instance of the novel plansformer 240A, which is evaluated using the evaluation phase 250A. In embodiments of the invention, the modeling phase 220A includes a domain model 222A, a problem generator 310, a progression planner 312, plans 314, training data 316, test data 230A, and a code-aware LLM 224A, configured and arranged as shown. The modeling phase 220A generates a novel plansformer 240A, which is an example instance of the novel plansformer 240 shown in FIG. 2. The evaluation phase 250A is operable to test the plansformer 240A and includes planner testing 252A and model testing 254A. In embodiments of the invention, the planner testing 252A includes generated plans 320, a VAL (validation) plan validation tool 322, plan validity functionality 324, and plan optimality functionality 326, configured and arranged as shown. In general, optimality is a property of optimization algorithms regarding whether their outcomes are maximal (for maximization problems) or minimal (for minimization problems). Model testing 254A utilizes a “ROUGE-L” 330 testing protocol for generating a first performance metric, and also uses a “BLEU” 332 model quality testing protocol for generating a second type of performance metric. Details of non-limiting example operations of the system 210A are described below.

An agent solving a planning problem is given the initial state, the goal state and a set of legal (or allowed) actions, and the objective is to find a sequence of actions that will take it from the initial to the goal state. Embodiments of the invention adopt the planning domain description language (PDDL) notations. In PDDL, a planning environment is described in terms of objects in the world, predicates that describe relations that hold between these objects, and actions that bring change to the world by manipulating these relations. The output plan includes a series of time steps, each of which can have one or more instantiated actions with concurrency semantics. A planner devises plans by searching in the space of states, where a state is a configuration of physical objects or partial plans. There is a single agent in the most basic formulation, called classical planning. The actions have unit cost, take constant time to execute, have deterministic effects, with the fully observable world, domain-specific conditions/constraints, and all goals have to be achieved. In more sophisticated planning settings, many of these conditions are relaxed. There may be multiple agents, and the cost and duration of actions can be non-uniform. At the same time, its effects can be non-deterministic, the world can be partially observable, and the agent can maximize as many goals as it can achieve in a given time and resource budget.

LLMs can be implemented as models that are pre-trained on extensive unstructured knowledge from public data. LLMs have demonstrated strong performance on several types of natural language processing (NLP) tasks. Recent progress in LLMs have used LLMs to transfer knowledge from pre-trained NL models to structured codes. Some embodiments include using an LLM that has been pre-trained to become code aware and to be proficient in one or more code-related tasks such as span denoising, contrastive learning, text-code matching, and causal language model pretraining. Unimodal and bimodal multilingual code corpora are used for such pretraining tasks. The LLM has an encoder-decoder architecture and then via the pre-training becomes a code-aware encoder-decoder architecture. In some method embodiments, the pre-training is included as a step of the method. In some instances, a benchmark dataset for code understanding and generation with sample codes from several programming languages, is used to fine-tune, an LLM and/or a code-aware LLM. CodeXGlue is an example of such a benchmark dataset for code understanding that can tune or fine tune an LLM and/or a code-aware LLM. In embodiments of the invention, the systems 210, 210A are configured and arranged to implement LLM 224A as an LLM configured and arranged to perform symbolic tasks such as harnessing symbols such as code for further fine-tuning the classical automated planning domain due to its ability to generate goal-directed, sequential instruction and semantically meaningful program codes with syntactic and structural constraints.

Turning now to a more detailed description of the system 210A shown in FIG. 3, in embodiments of the invention, the modeling phase 220A is used to create a planning-based dataset 316, 230A for fine-tuning the code-aware LLM 224A to generate the plansformer 240A. The modeling phase 220A depicts the various modules used to perform operations of the modeling phase 220A. In embodiments of the invention, a PDDL-based dataset 316, 230A is generated as a benchmark to fine-tune the pre-trained code-aware LLM 224A and facilitate further research by the modeling phase 220A at the intersection of LLMs and automated planning. As previously noted herein, fine-tuning is the process of taking a pre-trained model and training it on a new dataset. The pre-trained model has already learned features from a large dataset, and fine-tuning adapt these features to a new dataset. Fine-tuning is a feature of transfer learning where knowledge learned from one task by a NN is applied to another related task. Embodiments of the invention use the domain model 222A (e.g., in PDDL and a more-specific model such as Blocksworld,” “Towers of Hanoi,” “Grippers,” and “Driverlog”) to generate corresponding valid problem files with varying complexities automatically using a problem generator 310. The problem generator 310 analyzes possible variation in the domain model 222A to identify various sets of goals, initial states, and possible actions. In some embodiments, the problem generator 310 as a software module randomly generates different sets of these elements which together represent a problem (how to change the states to achieve the goal). A valid problem file in PDDL is a structured file that contains the name of the problem, the name of the planning domain, a list of objects, the initial state of the world, and the goal state(s) to be achieved. Examples of suitable classical planning domains include “Blocksworld,” “Towers of Hanoi,” “Grippers,” and “Driverlog.” Non-limiting examples of tasks, problem instances, and plans for valid problem files of Blocksworld are depicted at table 410 (shown in FIG. 4). The information passed from domain model 222A to problem generator 310 is the PDDL representation of a planning domain, which includes a set of objects, states and the available actions to transition from one state to another, together with their preconditions and effects.

Blocksworld (or “bw”) is a well-studied domain with blocks placed on a table or arranged in vertical stacks. In embodiments of the invention described herein, the arrangement of the blocks can be altered with the available actions such as pick-up, put-down, stack, and unstack. Embodiments of the invention generate the problems with two (2) to five (5) block configurations. Towers of Hanoi (or “hn”) includes three (3) pegs and multiple disks of varying diameters. Initially, all disks are placed in the first peg, and the end goal is to move the disks to the last peg. The only limitation to consider when moving the disks is that only a smaller disk can be placed on top of a bigger disk. Although the domain has only one action, the problem-solving is recursive. In embodiments of the invention, the problems are generated with configurations of two (2) to five (5) disks. The Grippers (or “gr”) domains involve moving balls across rooms using robotic grippers. It has problems generated with configurations of two (2) to five (5) balls; three (3) to five (5) robots; and two (2) to four (4) rooms. The Driverlog (or “dl”) domains involve moving packages on trucks between locations driven by drivers. It has problems generated with configurations of one (1) to three (3) drivers; one (1) to three (3) trucks; two (2) to four (4) packages; and three (3) to six (6) locations. Each planning domain explained above includes multiple problem instances, which are provided to the progression planner 312. More specifically, the problem generator 310 outputs the PDDL representation of a planning problem, which includes initial and goal states based on the information contained in the PDDL representation of the planning domain obtained from the domain model 222A. The combination of the domain model 222A and the problem generator 310 produces two outputs. One output is to the progression planner 312, and that output is a PDDL representation of a planning domain along with a PDDL representation of a planning problem for that domain. The other output is to the training data 316 and testing dataset 230A, and that output is a compact representation of the same PDDL planning domain and problem passed to the progression planner 312. Each instance of the training data 316 is configured to include a compact representation of the planning domain and a planning problem, along with a plan that solves that planning problem. Each instance of the test data 230A is configured to include a compact representation of the planning domain and a planning problem, along with a plan that solves that planning problem. The plans 314 are received from the branch running through the progression planner 312 and combined with the compact representation that came directly from the problem generator 310. Some of the problems/plans combinations are used as the training data 316 while others of the problems/plans combinations are used as the test data 230A.

Embodiments of the invention generate the corresponding plans 314 for each problem instance using the progression planner 312. Given a planning domain and a planning problem for that domain, the progression planner 312 produces a plan that solves the planning problem given as input. The progression planner searches a space of world states of a planning task in a forward direction. In some embodiments, the progression planner is a FastDownward planner as a classical planning system based on a heuristic search and which offers different search algorithms such as causal graph heuristics and “A*” search. FastDownward is an example of a progression planner and can generate optimal plans with “A*LM-Cut” heuristic. Thus, in aspects of the invention, the progression planner 312 can be regarded as a potent planner for generating a dataset of optimal plans. The table 410 shown in FIG. 4 provides a snapshot of the generated dataset for Blocksworld. Unlike the traditional planner, which requires two different files, namely domain and problem (as PDDL files), the plansformer 240A in accordance with aspects of the invention reduces the knowledge-engineering efforts with a simplified input format that includes the problem instance coupled with a corresponding valid plan. No explicit mention of predicates which are present in a domain file is required. No explicit mention of objects which are present in the problem file is required. The problem instance captures all of the essential information in the domain and the problem instance, such as the goal, the initial state, and the possible actions that can be taken in that domain. The generated dataset for each domain includes in an embodiment about eighteen thousand (18,000) plans with different problem configurations. For training, embodiments of the invention use five-fold cross-validation with an 80%-20% split of the generated dataset for each domain, where 80% of the split is training data 316 and 20% is the test data 230A. The average plan length (number of actions in the generated plan) for Blocksworld is nine (9), Grippers is nine (9), Driverlog is ten (10), and Towers of Hanoi is twelve (12).

In some embodiments of the invention, the LLM 224A includes or uses a so-called Byte-level Byte Pair Encoding (BPE) tokenizer, with a vocabulary size of about thirty-two thousand and five (32,005). Embodiments of the invention add PDDL-specific tokens, namely, [GOAL], [INIT], [ACTION], [PRE], [EFFECT] to represent the goal state, initial state, possible actions that change the states, associated preconditions, and effects these actions cause in the environment, respectively. Embodiments of the invention do not re-train a specific tokenizer for this task from scratch, which allows the tokenizer to be reused to generate code.

Embodiments of the invention described herein implement a code-aware LLM 224A that is pre-trained to perform one or more code generation and/or code understanding tasks. The code-aware LLM 224A includes an encoder-decoder stack inspired by the transformer architecture. In some embodiments the code-aware LLM 224A is a masked language model that attends to tokens on both sides of a masked word or a masked symbol. It is capable of performing a wide range of tasks including code generation and understanding tasks. The generation tasks include code summarization, code generation, translation, and refinement. The understanding tasks include code defect detection and clone detection. The code-aware LLM 224A in some embodiments is pretrained with example codes from one or more programming languages such as Python, Java, JavaScript, PHP, Ruby, Go, C, and/or C#. Its pre-training tasks include identifier awareness and bimodal generation, which optimizes code-to-code understanding. In some embodiments, the code-aware LLM 224A is a CodeT5 model which possesses several properties amenable to the planning domain, such as its ability to generate goal-directed, sequential instruction and semantically meaningful program codes with syntactic and structural constraints. With this pre-trained knowledge already encoded within the code-aware LLM 224A, embodiments of the invention fine-tune the code-aware LLM 224A with about fourteen thousand and four hundred (14,400) samples (about 80% of the generated dataset) for each independent domain from the planning dataset 316. Each sample of the training data is configured as a compact representation of the planning domain and a planning problem, along with a plan that solves that planning problem. As a result of this fine-tuning, the weights of the code-aware LLM 224A are updated to account for the task of plan generation. Embodiments of the invention provide the planning problem instance as input to the encoder of the code-aware LLM 224A and generate the intermediate features for the decoder of the code-aware LLM 224A to output a plan.

Thus, the plansformer 240A is a novel LLM that ingests a new input task/problem instance 242 as input and outputs a plan for that problem instance. The input task/problem instance 242 is the compact representation corresponding to a particular planning domain and a planning problem written in PDDL. The compact representation does contain symbols that represent the actions and the objects of the planning domain. An example of the input task/problem instance 242, which is passed as input to the plansformer 240A, is shown under the “problem instance” column of a table 410 shown in FIG. 4. The evaluation phase 250A is configured and arranged to evaluate the quality of the plansformer 240A as a model (the model testing 254A) and a planner (the planner testing 252A). Turning first to the planner testing 252A portion of the evaluation phase 250A, unlike in natural language, symbolic plans have richer information content, inherently captured in their structure. Embodiments of the invention provide an additional evaluation phase for plan validation to check how well the plansformer 240A can mimic an automated planner. The sequence of actions, i.e., the generated plans 320 from plansformer 240A must help an agent to navigate from the initial state to the goal state for a given problem instance. A generated plan 320 is referred to herein as “cost-optimal” if it is the shortest possible among all other plans. Several metrics exist in the automated planning literature to evaluate a plan generated by the plansformer 240A. In embodiments of the invention, the planner testing 252A considers validity 324 and optimality 326. In embodiments of the invention, the plan generated 320 by the plansformer 240A is evaluated using a plan validation tool known as VAL 322 to check for its optimality 326 and validity 324. VAL 322 is an automatic validation tool for PDDL. VAL 322 is a software module that takes as input the task posed to the plansformer 240A and the corresponding generated plan 320. VAL applies PDDL-based relaxation conditions to check for validity and optimality.

Turning now to the model testing 254A portion of the evaluation phase 250A, it is known to evaluate natural language tasks such as summarization or generation using metrics such as BLEU 332 and ROUGE-L 330. Both BLEU 332 and ROUGE-L 330 are widely used metrics in NLP. In general, BLEU 332 measures precision and helps understand how closely a machine translation (here, the plan generated by the plansformer 240A) is compared to a human translation (here, the plan generated by an automated planner). On the other hand, ROUGE-L 330 measures recall, i.e., how many of the words referenced in human summaries appeared in the summaries generated by the machine. In particular, embodiments of the invention adopt ROUGE-L 330, which considers sentence-level structure similarity by identifying the longest co-occurring sequence n-grams. Although ROUGE-L 330 and BLEU 332 have no direct intuition in automated planning, embodiments of the invention use these metrics to look at the task of plan generation from the perspective of LLMs. These model performance metrics are performed on the produced plans (e.g., a batch of generated plans equivalent to generated plans 320) as compared to ground truth plans (e.g., plans generated by the progression planner 312). Because the plans are sequences of tokens, the natural language metrics are applied to the plans to evaluate the sequence generation capability of the plansformer 240A. The natural language metric tools do not need to have any awareness that the produced plans are plans; rather, these natural language metric tools merely analyze the plans as a sequence of tokens. In accordance with aspects of the invention, the evaluation based on these metrics provides an insight into the performance of the plansformer 240A as a language model.

Embodiments of the invention have been evaluated under test conditions. Presented herein are the quantitative and qualitative results obtained using the plansformer 240, 240A to generate symbolic plans for multiple domains of varying complexities. A test-bed of three-thousand six hundred (3,600) unique and unseen problem instances (20% of the dataset) for each domain was selected for evaluating the plansformer 240, 240A. All of the results reported herein are averaged over five (5) randomly selected (80%-20%) train-test splits. The results for the plansformer variants are reported herein by evaluating the corresponding test-bed. For example, plansformer-bw's results are reported based on the performance results obtained on bw test-bed. The plansformer 240, 240A is evaluated using both model testing 254A and planner testing 252A to find its efficiency as a language model and a planner.

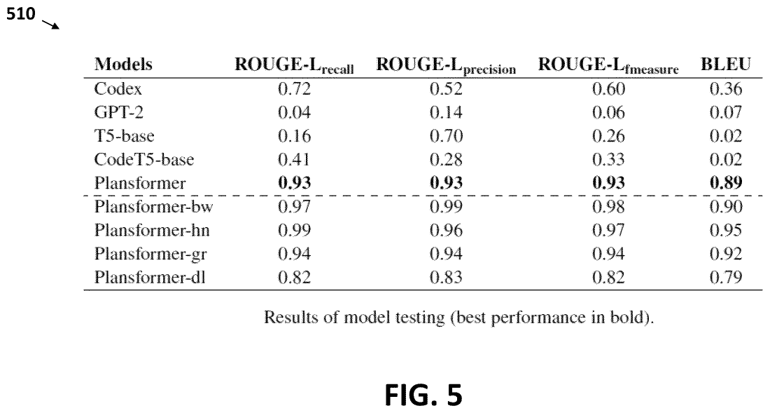

In embodiments of the invention, the plansformer 240, 240A includes an encoder-decoder pair, where the encoder attends to tokens on either side of the masked word, whereas the decoder auto-regressively generates plans. Table 510 shown in FIG. 5 compares all of the plansformer models with other LLMs using the model evaluation metrics (ROUGE and BLEU). In this experiment, the best-performing models are considered from (bidirectional) masked language models (e.g., T5) and (unidirectional) causal language models (e.g., GPT-2) for the experiments.

The performance of the baseline models is averaged over the four planning domains. The performance of the disclosed plansformer 240, 240A on individual domains (Plansformer-bw, Plansformer-hn, Plansformer-gr and Plansformer-dl) is also shown. It can be observed that the plansformer 240, 240A performs best on all metrics, followed by Codex, with a significant ROUGE-Lrecall score. The performance gain from Codex compared to other baseline models is most likely due to its ability to relate the natural language understanding (a skill inherited from GPT-3) with code generation. It is worth noting that CodeT5 performs poorly compared to Codex and the plansformer 240, 240A, which demonstrates the advantages of the natural language understanding with code generation task on this evaluation metric. Accordingly, the models pre-trained with code-related tasks have an advantage over other models in plan generation task due to the similarities of PDDL with other programming languages.

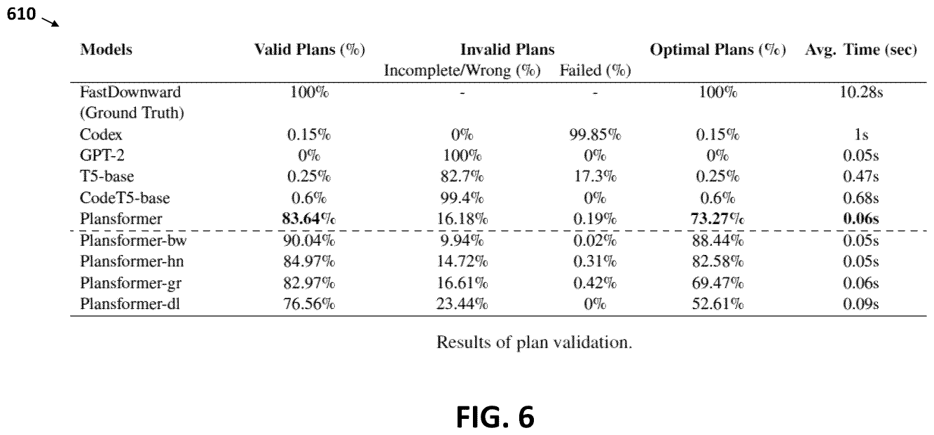

The plansformer 240, 240A has been tested for plan validation to determine its effectiveness as a planner. The results from the planner testing will now be described. The generated plans were evaluated for validity and optimality. The average time taken to solve the problem instances are also reported. The table 610 (shown in FIG. 6) shows the plan validation scores obtained by different models. The FastDownward was used for plan validation to generate the ground truth plans. The FastDownward planner generates a 100% valid and optimal plan for a given input (i.e., a combination of domain description and problem instance) when the landmark-cut heuristic is used within a standard A* search framework.

It can be seen from table 610 (shown in FIG. 6) that Blocksworld bw domain achieved the highest performance gain via Plansformer-bw—generated 90.04%, out of which 88.44% are optimal. This better performance is analogous to the fact that bw is the easiest domain among the four domains. Although it is hard to find optimal plans, one can find a valid plan linear in the number of blocks to any problem instances by putting them down and picking from the table.

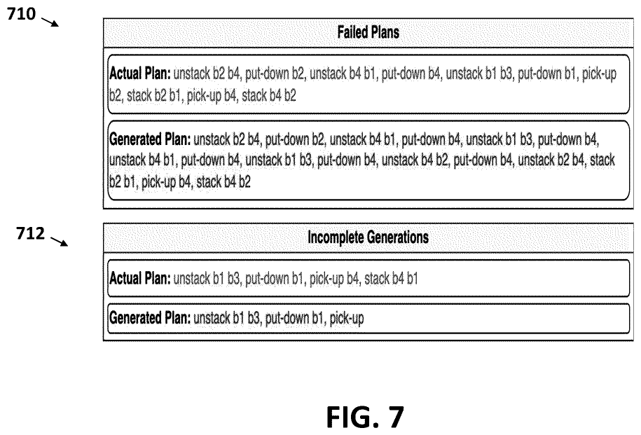

On a relatively more complex domain, i.e., dl, Plansformer-dl achieves 76.56% valid plans, out of which 52.61% are optimal. A 20% difference between valid and optimal plans for dl is noted, with an observation that the model can come up with completely new and valid action sequences, although they may not be optimal. The number of optimal plans generated reduces with the increasing complexity of the domains. The table 610 includes both incomplete/wrong generations from the models and failed plans when reporting invalid plans. An incomplete/wrong generation is a partially correct ordering of action sequences, whereas a failed plan is an entire plan consists of impossible ordering of actions, not allowed by the domain definition. FIG. 7 depicts examples of incomplete generation 712 and failed plans 710. All plansformers (or plansformer models) 240, 240A generate close to 0% failed plans for respective domains, which represents a strong ability of the plansformer models 240, 240A to understand and generate valid action sequences for a given domain.

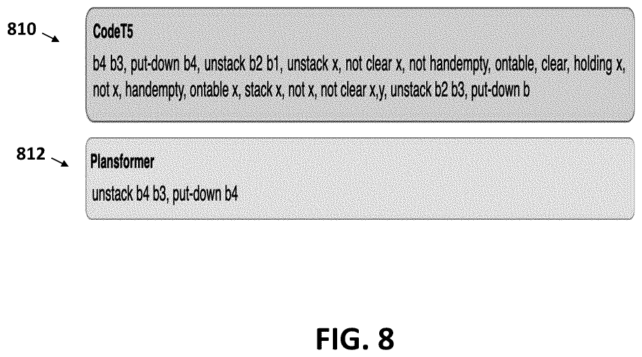

Codex, the second best performing model according to ROUGE and BLEU scores, only generates 0.15% valid plans, emphasizing the need for a two-stage evaluation phase—where both model and generated plans are tested. The average time taken by the plansformer 240, 240A to completely solve the test-bed of problems is around 200 times faster than the FastDownward, an automated planner that generated ground truth plans. Accordingly, in embodiments of the invention, the plansformer 240, 240A can offer an immense advantage in generating approximately correct plans in real-time applications. Interestingly, CodeT5, used in some embodiments to build the disclosed plansformer, takes considerable time to solve the same problem instances from the test bed. Thus, the plansformer 240, 240A is faster because it generates valid and likely optimal plans shorter in length than usually long incoherent sequences generated by CodeT5, which tend to be time-consuming. The difference between plans generated by CodeT5 810 and the plans 812 generated by the plansformer for the same problem is shown in FIG. 8. Thus, the plansformer 240, 240A, trained and tested on the same domain, displays superior performance both as a model and a planner.

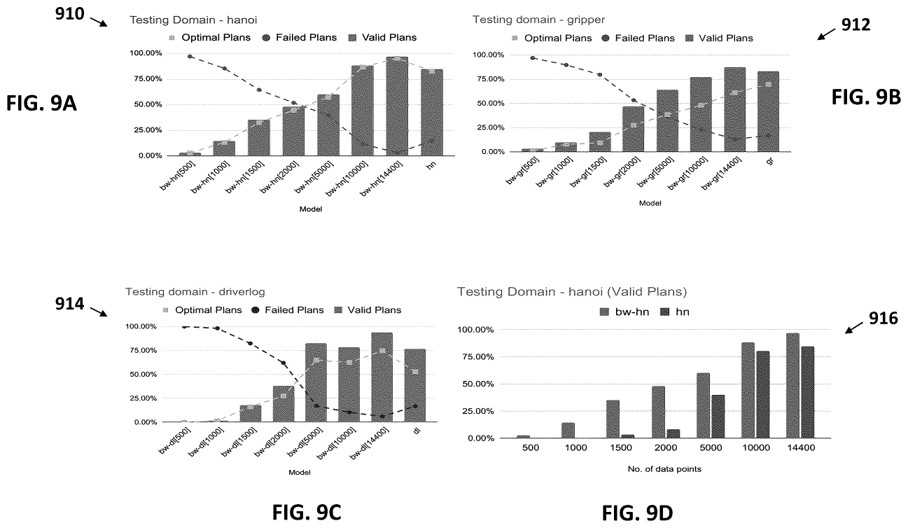

In some embodiments of the invention, the use of LLMs allows the plansformer 240, 240A to utilize the model trained in one domain to adapt to another using either making use of prompt conditioning or transfer learning with further fine-tuning on the problem instances from the new domain. The performance of the model on an unseen domain is very sensitive to the manually-identified prompt. A small perturbation to the prompt can significantly affect the model's performance, and creating a perfect prompt requires understanding the inner workings of LLM on hand and trial and error. However, instead of the prompt conditioning, embodiments of the invention follow the transfer learning approach by fine-tuning the plansformer-based models with problem instances from other domains to check the ability of the plansformer 240, 240A to adapt to new domains. A demonstration of variants of Plansformer-bw models on three other domains is depicted in at 910, 912, 914, 916 shown in FIGS. 9A-9D, respectively. FIGS. 9A-9D show different Plansformer-bw models and their plan validation scores on respective test-bed from target domains. The results for transfer learning setup of plansformer-based models convey the same insights as Plansformer-bw shown here.

Different numbers of problem instances for fine-tuning Plansformer-bw on a given domain are evaluated to determine how the performance of the model varies across the sample size. The model naming format is used to convey the details on the amount of problem instances used for fine-tuning the Plansformer base model, i.e., bw-hn implies that Plansformer-bw is further fine-tuned using five-hundred (500) problem instances from hn and the results are reported. FIGS. 9A-9D depict an overall increase in the number of valid plans for every testing domain as the problem instances available for finetuning are increased. It can be noted that the models fine-tuned with 2000, which is 14% of the training size of base models, achieves 50% of the valid plans recorded by Plansformer-hn, Plansformer-gr, and Plansformer-dl. Despite the complexity of these planning domains, FIGS. 9A-9D convey Plansformer-bw as the base model fine-tuned with and tested on (FIG. 9A) Hanoi (FIG. 9B) Grippers (FIG. 9C) Driverlog, and (FIG. 9D) shows the comparison of valid plans generated by Plansformer-bw-hn derived models with Plansformer-hn trained using similar data points.

Greater than about 90% valid plans can be seen for all testing domains by increasing the finetuning samples to that of the training size of base models. Plansformer-bw-hn obtains the best performance among all models, by achieving 97.05% valid plans, out of which 95.22% are optimal. In FIG. 9D, Plansformer-hn trained with different number of data points from hn domain is compared against the Plansformer-bw (base model) fine-tuned on the same data points. A clear advantage of the transfer learning capability in LLMs is observable, as both the bw and hn domains have similar plan semantics. Similar trends can be seen for the other domains.

It is noted that the failed plans decrease with additional problem instances used for finetuning. Using the same amount of problem instances as training (about 14, 400), it can be observed that the number of failed plans is less than that of the base models built for the respective domains. The number of optimal plans consistently increases with the number of problem instances in hn domain for finetuning. It is 13% more than Plansformer-hn, whereas some variations can be seen for the other two domains.

Thus, it can be seen from the foregoing detailed description that embodiments of the invention provide technical benefits and technical effects. Embodiments of the invention use LLMs to generate symbolic plans for multiple domains. Embodiments of the invention take an LLM tailored to code and trains it further over a set of planning problem instances and corresponding valid plans. Embodiments of the invention further test the model's capability to generate plans for unseen planning problem instances, evaluating the correctness and length of such plans. The plansformer generated in accordance with aspects of the invention is compared to an existing state-of-the-art planner, showing that the disclosed LLM-based planner, referred to herein as a plansformer, can solve most instances with high quality both in terms of correctness and length while needing much less time to generate such plans.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
inputting a first input into a plansformer comprising a transformer-based neural network (NN), the first input comprising symbols and a problem; and
in response to the inputting, receiving as output from the plansformer a plan for solving the problem.

2. The computer-implemented method of claim 1, wherein the symbols comprise computer code.

3. The computer-implemented method of claim 1, wherein the plan comprises more symbols.

4. The computer-implemented method of claim 1, further comprising training the plansformer via submitting training data to a large language model (LLM).

5. The computer-implemented method of claim 4, wherein the training data comprises planning problems and associated plans generated from a test domain.

6. The computer-implemented method of claim 5, wherein:
the planning problems are received from a problem generator in response to a domain model being input into the problem generator; and
the associated plans are received from a progression planner in response to the planning problems being input into the progression planner.

7. The computer-implemented method of claim 4, wherein the LLM comprises a code-aware encoder-decoder architecture.

8. The computer-implemented method of claim 7, wherein the code-aware encoder-decoder architecture is pre-trained using one or more code-related tasks selected from a group consisting of code summarization, code generation, code translation, code refinement, code defect detection, code clone detection, and text-code matching.

9. The computer-implemented method of claim 4, wherein the code-aware encoder-decoder architecture implements masked language modeling.

10. The computer-implemented method of claim 1, further comprising evaluating the plan to produce a confidence score.

11. The computer-implemented method of claim 1, further comprising evaluating the plan for validity and optimality.

12. The computer-implemented method of claim 11, wherein the evaluating for validity and optimality comprises applying relaxation conditions to the plan and the first input.

13. The computer-implemented method of claim 1, further comprising evaluating the plan via a natural language metric tool.

14. The computer-implemented method of claim 1, wherein the plan comprises a series of time steps and one or more actions to instantiate for each of the time steps.

15. The computer-implemented method of claim 1, wherein the plansformer comprises a tokenizer that produces planning-language specific tokens.

16. A computer system comprising a processor system electronically coupled to a memory, wherein the processor system performs processor system operations comprising:
inputting a first input into a plansformer comprising a transformer-based neural network (NN), the first input comprising symbols and a problem; and
in response to the inputting, receiving as output from the plansformer a plan for solving the problem.

17. The computer system of claim 16, wherein:
the symbols comprise computer code;
the plan comprises more symbols;
the processor system operation further comprise training the plansformer via submitting training data to a large language model (LLM); and
the training data comprises planning problems and associated plans generated from a test domain.

18. The computer system of claim 17, wherein:
the planning problems are received from a problem generator in response to a domain model being input into the problem generator;
the associated plans are received from a progression planner in response to the planning problems being input into the progression planner; and
the LLM comprises a code-aware encoder-decoder architecture.

19. A computer program product comprising a computer readable program stored on a computer readable storage medium, wherein the computer readable program, when executed on a processor system, causes the processor to perform processor system operations comprising:
inputting a first input into a plansformer comprising a transformer-based neural network (NN), the first input comprising symbols and a problem; and
in response to the inputting, receiving as output from the plansformer a plan for solving the problem,
wherein the symbols comprise computer code;
wherein the plan comprises more symbols; and
training the plansformer via submitting training data to a large language model (LLM);
wherein the training data comprises planning problems and associated plans generated from a test domain.

20. The computer program product of claim 19, wherein:
the planning problems are received from a problem generator in response to a domain model being input into the problem generator;
the associated plans are received from a progression planner in response to the planning problems being input into the progression planner; and
the LLM comprises a code-aware encoder-decoder architecture.
